(19) United States
(12) Patent Application Publication
(10) Pub. No.: US 2024/0340965 A1
(43) Pub. Date: Oct. 10, 2024

(54) RESOURCE ALLOCATION AND TRANSMISSION METHOD AND APPARATUS FOR UPLINK SIGNAL

(71) Applicant: Samsung Electronics Co., Ltd., Suwon-si (KR)

(72) Inventors: Qi XIONG, Beijing (CN); Feifei SUN, Beijing (CN)

(21) Appl. No.: 18/623,266

(22) Filed: Apr. 1, 2024

(30) Foreign Application Priority Data
Apr. 4, 2023 (CN) 202310358007.X
Apr. 19, 2023 (CN) 202310420662.3
Nov. 1, 2023 (CN) 202311445211.1

(51) Int. Cl. H04W 74/0833; H04W 24/10; H04W 52/36; H04W 72/1273

(52) U.S. Cl. CPC H04W 74/0833; H04W 24/10; H04W 52/36; H04W 72/1273

(57) ABSTRACT

A method performed by user equipment (UE) in a communication system is provided. The method includes receiving configuration information related to random access, wherein the configuration information includes at least one of first information on a number of physical random access channel (PRACH) transmissions associated with a random access attempt, or a maximum value related to the random access, and transmitting a first number of PRACHs, wherein the first number is determined based on the maximum value or the first information.

### CROSS-REFERENCE TO RELATED APPLICATION(S)

This application is based on and claims priority under 35 U.S.C. § 119 (a) of a Chinese patent application number 202310358007.X, filed on Apr. 4, 2023, in the China National Intellectual Property Administration, of a Chinese patent application number 202310420662.3, filed on Apr. 19, 2023, in the China National Intellectual Property Administration, and of a Chinese patent application number 202311445211.1, filed on Nov. 1, 2023, in the China National Intellectual Property Administration, the disclosure of each of which is incorporated by reference herein in its entirety.

### BACKGROUND

### 1. Field

The disclosure relates to a resource allocation and transmission method for an uplink signal in a wireless communication system, and corresponding apparatus.

### 2. Description of Related Art

5th generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as millimeter-wave (mmWave) including 28 GHz and 39 GHZ. In addition, it has been considered to implement 6th generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a resource allocation and transmission method for an uplink signal in a wireless communication system, and corresponding apparatus.

Additional aspects will be set forth in part in the description which follows and, in part, will be apparent from the description, or may be learned by practice of the presented embodiments.

In accordance with an aspect of the disclosure, a method performed by user equipment (UE) in a wireless communication system is provided. The method includes receiving configuration information related to random access, wherein the configuration information includes at least one of first information on a number of physical random access channel (PRACH) transmissions associated with a random access attempt, or a maximum value related to random access and transmitting a first number of PRACHs, wherein the first number is determined based on the maximum value or the first information.

In an implementation, wherein, the first information includes a set of the numbers of PRACH transmissions, or the first information includes the number of numeral values in the set of the numbers of PRACH transmissions, wherein the numeral values in the set correspond to one or more numbers of PRACH transmissions.

In an implementation, wherein, the maximum value is a maximum value of the numbers of times of PRACH transmissions, or a maximum value of the numbers of times of random access attempts.

In an implementation, wherein, the maximum value includes maximum values corresponding to each of numeral values in the numbers of PRACH transmissions, or by rounding a ratio of the maximum value to the number of the numbers of PRACH transmissions, a maximum value related to random access which corresponds to each numeral value of the numbers of PRACH transmissions is obtained.

In an implementation, wherein, transmitting PRACH based on the first information according to the maximum value, comprises, if the first number of PRACH transmissions associated with the current random access attempt is less than the maximum numeral value among the numbers, and a counter related to random access reaches a maximum value corresponding to the first number, transmitting the PRACH based on a second number among the numbers, wherein the second number is greater than the first number.

In an implementation, wherein, a value of the counter related to random access is increased according to the first number.

In an implementation, the method further comprises determining the number of PRACH transmissions associated with the random access attempt among the numbers according to a measurement result of a downlink signal and determining the first number based on the determined number of PRACH transmissions associated with the random access attempt and/or the maximum value.

In an implementation, wherein, each numeral value among the numbers corresponds to a different range of a measurement result, and the determined number of PRACH transmissions associated with the random access attempt is determined based on a range to which the measurement result belongs.

In an implementation, wherein, the configuration information further includes power related configuration information corresponding to each numeral value among the numbers, wherein the power related configuration information includes at least one of PRACH received power, a pathloss compensation coefficient, and a PRACH power ramping step.

In an implementation, wherein, if the first number is different from the number of PRACH transmissions corresponding to the previous random access attempt, a preamble power ramping counter is increased by 1, otherwise, a value of the preamble power ramping counter remains unchanged.

In an implementation, wherein, if a power value equivalently increased by an increment between the first number and the number of PRACH transmissions corresponding to the previous random access attempt is not greater than the preamble power ramping step, or a difference between the power value equivalently increased and the preamble power ramping step is not greater than a first threshold, the preamble power ramping counter is increased by 1, otherwise, the value of the preamble power ramping counter remains unchanged.

In an implementation, wherein, the number of PRACH transmissions corresponding to the previous random access attempt is the number of PRACHs transmitted in the previous random access attempt, or a configured number of PRACHs associated with the previous random access attempt.

In an implementation, wherein, if the first number is less than or equal to the number of PRACHs transmitted in the previous random access attempt, the preamble power ramping counter is increased by 1, otherwise, the value of the preamble power ramping counter remains unchanged.

In accordance with another aspect of the disclosure, a method performed by UE in a wireless communication system is provided. The method includes determining a number of PRACH transmissions associated with a random access attempt and corresponding random access occasions (ROs) based on configuration information related to random access, determining to cancel a PRACH transmission on a first RO among the ROs, and performing PRACH transmissions on other ROs among the ROs, wherein the first RO is determined according to at least one of priority related to power allocation, whether a symbol on the RO is flexible or not, or an interval between the PRACH transmission on the RO and other signal transmissions.

In an implementation, the method further comprises informing a higher layer to suspend the preamble power ramping counter, or informing the higher layer of the number of PRACHs transmitted, or if the number of the first ROs is greater than a third threshold, informing the higher layer to suspend a PRACH transmission counter or a random access attempt counter, or informing the higher layer to decrease a value of the PRACH transmission counter by the number of the first ROs (that is, a value of the PRACH transmission counter minus the number of the first ROs) or to decrease a value of the random access attempt counter by 1 (that is, a value of the random access attempt counter minus 1).

In an implementation, wherein, according to the priority related to power allocation, the priority of a single PRACH transmission is higher than that of a PRACH transmission of multiple PRACH transmissions, or the priority of the PRACH transmission on a primary cell is higher than that of the PRACH transmission on other serving cells.

In an implementation, wherein, the PRACH transmission on the RO with an index number after and/or before the first RO among the ROs is also canceled.

In an implementation, the PRACH transmission on a RO between the ROs among the first ROs is also canceled.

In an implementation, the method further comprises if the number of other ROs is less than or equal to the number of PRACH transmissions associated with the previous random access attempt or the previous number of PRACH transmissions during random access, canceling the PRACH transmissions on all ROs among the ROs.

In accordance with another aspect of the disclosure, a method performed by UE in a wireless communication system is provided. The method includes transmitting a PRACH based on a number of PRACH transmissions associated with a random access attempt and monitoring a physical downlink control channel (PDCCH) related to a random access response (RAR) related to the PRACH, wherein a random access radio network temporary identifier (RA-RNTI) related to scrambling of the PDCCH is determined based on the number of PRACH transmissions.

In an implementation, wherein, if the number of PRACH transmissions is 1, the RA-RNTI is determined based on an index of a first orthogonal frequency division multiplexing (OFDM) symbol of a RO of a single PRACH transmission corresponding to the number of PRACH transmissions, and if the number of PRACH transmissions is greater than 1, the RA-RNTI is based on an index of a second or the last OFDM symbol of a w-th RO among the ROs corresponding to the PRACH transmissions, wherein w is obtained by rounding operation on the number of PRACH transmissions divided by 2.

In accordance with another aspect of the disclosure, a user equipment (UE) in a wireless communication system is provided. The UE includes a transceiver, and one or more processors communicatively coupled to the transceiver, wherein the one or more processors are configured to receive configuration information related to random access, wherein the configuration information comprises at least one of first information on a number of physical random access channel (PRACH) transmissions associated with a random access attempt, or a maximum value related to the random access, and transmit a first number of PRACHs, wherein the first number is determined based on the maximum value or the first information.

In accordance with another aspect of the disclosure, one or more non-transitory computer-readable storage media storing one or more computer programs including computer-executable instructions that, when executed by one or more processors of a user equipment (UE), cause the UE to perform operations are provided. The operations include receiving configuration information related to random access, wherein the configuration information comprises at least one of first information on a number of physical random access channel (PRACH) transmissions associated with a random access attempt, or a maximum value related to the random access, and transmitting a first number of PRACHs, wherein the first number is determined based on the maximum value or the first information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an example wireless network according to an embodiment of the disclosure;

FIG. 2A is an example wireless transmission path according to an embodiment of the disclosure;

FIG. 2B is an example wireless reception path according to an embodiment of the disclosure;

FIG. 3A is example user equipment (UE) according to an embodiment of the disclosure;

FIG. 3B is an example base station according to an embodiment of the disclosure;

FIG. 4 is a schematic diagram of an example random access process according to an embodiment of the disclosure;

FIG. 5 is a schematic diagram of a corresponding situation of a value of N and a value of w according to an embodiment of the disclosure; and

FIG. 6 is a schematic diagram of an example wireless device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It should be understood that the singular forms “a,” “an,” and “the” include plural referents unless the context clearly dictates otherwise. Thus, for example, reference to “a component surface” includes reference to one or more of such surfaces.

Besides, it should be understood that ordinal numbers such as first and second used throughout the disclosure are not intended to imply order or importance, but are merely used to distinguish one element from another, unless the context clearly indicates otherwise.

The term “include” or “may include” which may be used in describing various embodiments of the disclosure refers to the existence of a corresponding disclosed function, operation or component which can be used in various embodiments of the disclosure, rather than limiting one or more additional functions, operations, or components. In addition, the terms such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of terms listed. For example, “A or B” may include A, may include B, or may include both A and B.

Unless otherwise specified, all of the terms which are used herein (including the technical or scientific terms) have the same meanings as those that are generally understood by a person having ordinary knowledge in the art to which the disclosure pertains. The terms defined in a generally used dictionary must be understood to have meanings identical with those used in the context of a related art, and are not to be construed to have ideal or excessively formal meanings unless they are obviously specified in the disclosure.

The technical solution of the application can be applied to various communication systems, for example: a global system for mobile communications (GSM) system, a code division multiple access (CDMA) system, a wideband code division multiple access (WCDMA) system, general packet radio service (GPRS), a long term evolution (LTE) system, an LTE frequency division duplex (FDD) system, LTE time division duplex (TDD), a universal mobile telecommunication system (UMTS), a worldwide interoperability for microwave access (WiMAX) communication system, a fifth generation (5G) system or new radio (NR), etc. In addition, the technical solution of the embodiments of the disclosure can be applied to future-oriented communication technology.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

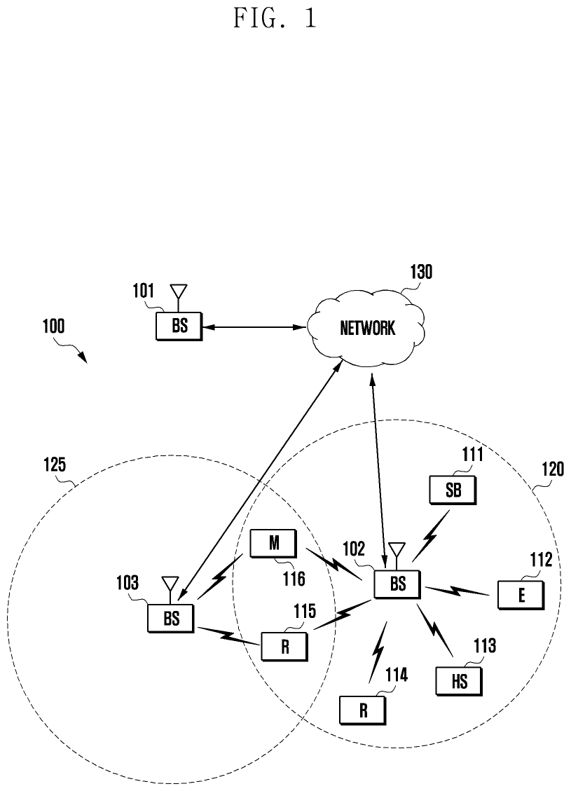

FIG. 1 is a schematic diagram of an example wireless network 100 according to an embodiment of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. The gNB 101 communicates with gNB 102 and gNB 103. The gNB 101 also communicates with at least one network 130, such as the Internet, a private Internet Protocol (IP) network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. Moreover, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a Wi-Fi Hotspot (HS); a UE 114, which may be located in a first residence (R); a UE 115, which may be located in a second residence (R); a UE 116, which may be a mobile device (M), such as a cellular phone, a wireless laptop computer, a wireless personal digital assistant (PDA), etc. The gNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-advanced (LTE-A), WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2-dimensional (2D) antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. For example, the wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

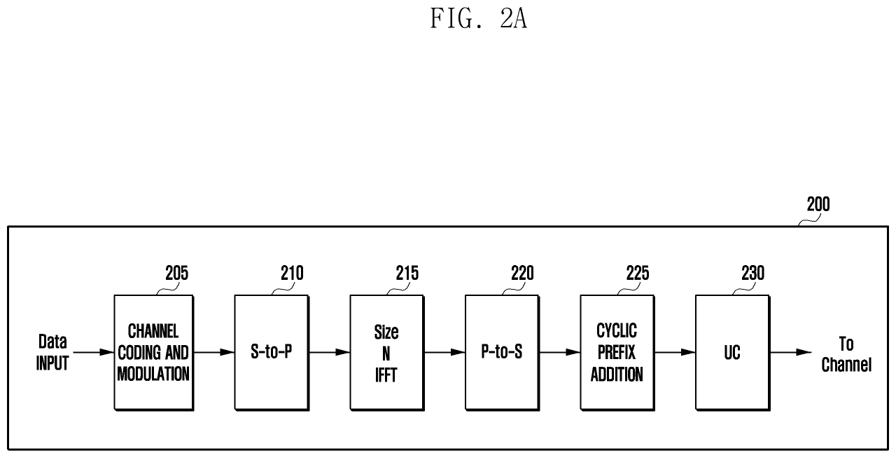

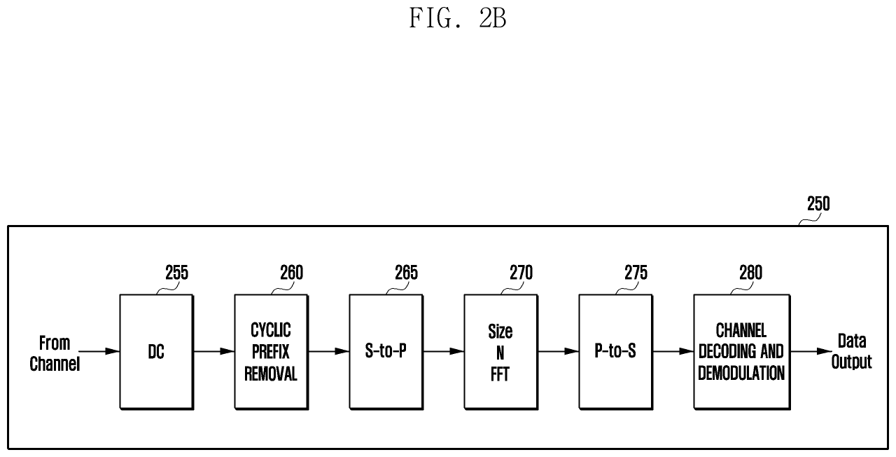

FIGS. 2A and 2B are example wireless transmission and reception paths according to various embodiment of the disclosure.

In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to a radio frequency (RF) frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

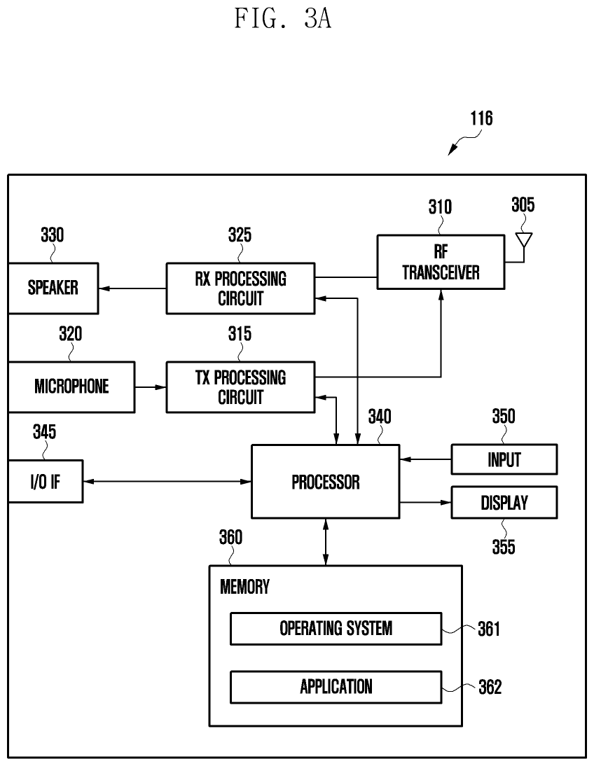

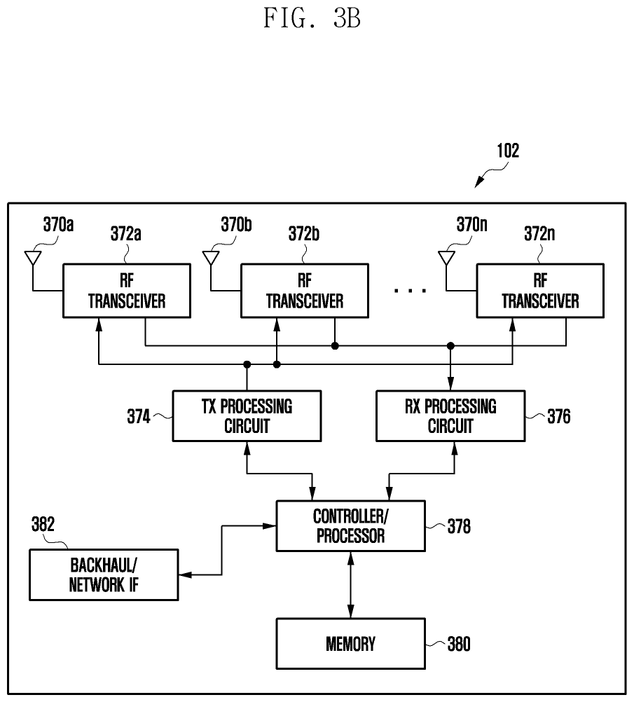

FIG. 3A illustrates an example UE 116 according to an embodiment of the disclosure.

The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

The UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, wherein the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of performing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, wherein the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to an embodiment of the disclosure.

The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

Referring to FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. The gNB 102 also includes a controller/processor 378, memory 380, and a backhaul or network interface 382.

RF transceivers 372a-372n receive an incoming RF signal from antennas 370a-370n, such as a signal transmitted by UEs or other gNBs. The RF transceivers 372a-372n down-convert the incoming RF signal to generate an IF or baseband signal. The IF or baseband signal is transmitted to the RX processing circuit 376, wherein the RX processing circuit 376 generates a processed baseband signal by filtering, decoding and/or digitizing the baseband or IF signal. The RX processing circuit 376 transmits the processed baseband signal to controller/processor 378 for further processing.

The TX processing circuit 374 receives analog or digital data (such as voice data, network data, email or interactive video game data) from the controller/processor 378. The TX processing circuit 374 encodes, multiplexes and/or digitizes outgoing baseband data to generate a processed baseband or IF signal. The RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of performing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web real-time communications (RTCs). The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the processor/controller 378. A part of the memory 380 can include a RAM, while another part of the memory 380 can include a flash memory or other ROMs. In some embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3B. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

A time domain unit (also called time unit) in the application may be: an OFDM symbol, an OFDM symbol group (composed of multiple OFDM symbols), a slot, a slot group (composed of multiple slots), a subframe, a subframe group (composed of multiple subframes), a system frame, and a system frame group (composed of multiple system frames), or may be an absolute time unit, such as 1 millisecond, 1 second, etc. The time unit may also be a combination of various granularities, such as N1 slots plus N2 OFDM symbols.

A frequency domain unit (also called frequency unit) in the application may be: a subcarrier, a subcarrier group (composed of multiple subcarriers), a resource block (RB), which may also be called a physical resource block (PRB), a resource block group (composed of multiple RBs), a bandwidth part (BWP), a BWP group (composed of multiple BWPs), a frequency band/carrier, a frequency band group/carrier group, or may be an absolute frequency domain unit, such as 1 Hz, 1 kHz, etc. The frequency domain unit may also be a combination of multiple granularities, such as M1 PRBs plus M2 subcarriers.

The various embodiments of the disclosure are further described below in conjunction with the accompanying drawings.

The text and drawings are provided as examples only to help readers understand the disclosure. They are not intended and should not be interpreted as limiting the scope of the disclosure in any way. Although certain embodiments and examples have been provided, based on the content disclosed herein, it is obvious to those skilled in the art that modifications to the illustrated embodiments and examples can be made without departing from the scope of the disclosure.

It should be further understood that terms “include/including” used in this specification of the application specify the presence of the stated features, integers, steps, operations, elements and/or components, but not exclusive of the presence or addition of one or more other features, integers, steps, operations, elements, components, and/or combinations thereof. It should be understood that when a component is referred to as being “connected to” or “coupled to” another component, it may be directly connected or coupled to other elements or provided with intervening elements therebetween. In addition, “connected to” or “coupled to” as used herein may include wireless connection or coupling. As used herein, term “and/or” includes all or any of one or more associated listed items or combinations thereof.

It should be understood by those skilled in the art that, unless otherwise specified, all of the terms used herein (including the technical or scientific terms) have the same meanings as those that are generally understood by a person having ordinary knowledge in the art to which the disclosure pertains. It also should be understood that such terms as those defined in a generally used dictionary are to be construed to have the meanings equal to the contextual meanings in the relevant field of art, and are not to be interpreted to have ideal or excessively formal meanings unless clearly defined in the specification.

It may be understood by those skilled in the art that the “terminal” and “terminal device” used herein not only include devices with wireless signal receiver, i.e., devices with merely a wireless signal receiver without transmission function, but also include devices including both receiving and transmitting hardware which may perform bidirectional receiving and transmitting on a bidirectional communication link. The device may include: cellular or other communication devices which may include a single line display or multi-line display or not include a multi-line display; Personal Communications Service (PCS) which may combine voice, data processing, fax and/or data communication functions; Personal Digital Assistant (PDA) which may include a radio frequency receiver, a pager, internet/intranet visit, network browser, notebook calendar and/or Global Positioning System (GPS) receiver; a conventional laptop and/or palm computer or other devices, including conventional laptop and/or palm computer or other devices equipped with radio frequency receiver. The “terminal” and “terminal device” used herein may be portable, transportable, and can be installed in a vehicle (aviation, maritime and/or land), or may be applicable for and/or configured as operating locally, and/or operating in a distributed manner at any position of the earth and/or space. The “terminal” and “terminal device” used herein may also refer to a communication terminal, an Internet terminal, a music/video player terminal, e.g., PDA, Mobile Internet Device (MID), and/or a mobile phone with a music/video playing function, or may be smart TVs, set-top box, etc.

Without departing from the scope of the disclosure, the term “send” in the disclosure can be used interchangeably with “transmit”, “report”, “notify”, etc.

The text and drawings are provided as examples only to help readers understand the disclosure. They are not intended and should not be interpreted as limiting the scope of the disclosure in any way. Although certain embodiments and examples have been provided, based on the content disclosed herein, it is obvious to those skilled in the art that modifications to the illustrated embodiments and examples can be made without departing from the scope of the disclosure.

A transmission link of a wireless communication system mainly includes: a downlink communication link from 5G gNB to User Equipment (UE), and an uplink communication link from UE to network.

Nodes used for positioning measurement in a wireless communication system, such as a current wireless communication system, include: UE initiating a positioning request message, a location management function (LMF) entity for UE positioning and positioning assistance data sending, gNB or transmission-reception point (TRP) for broadcasting the positioning assistance data and performing uplink positioning measurement, and UE for downlink positioning measurement. In addition, the method provided by the disclosure may also be extended to other communication systems, such as automobile communication (V2X), that is, sidelink communication, in which the transmission-reception point or UE may be any device in V2X.

The transmission in the wireless communication system includes: a transmission (called downlink transmission) link from a base station (gNB) to user equipment (UE) with a corresponding slot being called a downlink slot, and a transmission (called uplink transmission) from UE to base station with a corresponding slot being called an uplink slot.

In the downlink communication of the wireless communication system, a synchronization signal and broadcast channel are periodically transmitted by the system to a user through a synchronization signal/physical broadcast channel (PBCH) block (SSB), and the periodicity is SSB periodicity, or SSB burst periodicity. Meanwhile, the base station may configure a physical random access channel (PRACH) configuration period, a certain number of random access transmission occasions (also called random access occasions, PRACH transmission occasions, ROs) are configured within this period, and it is satisfied that all of SSBs can be mapped onto the corresponding ROs within an association period (that is, a certain time length). In a mapping cycle from SSB to RO, SSBs in one SSB periodicity can be just completely mapped to required random access resources, and there may be one or more mapping cycles in one mapping cycle. An association pattern period from SSB to RO includes one or more association periods, and an association pattern from SSB to RO in each association pattern period is the same.

In a new radio communication system, prior to establishing radio resource control, for example, during random access, the performance of random access directly affects the experience of the user. In the traditional wireless communication system, e.g., in the LTE and LTE-Advanced, the random access process is applied to multiple scenarios, for example, establishment of initial link, cell switch, reestablishment of uplink connection, reestablishment of radio resource control (RRC) connection, etc., and is divided into contention-based random access and contention-free random access according to whether the user exclusively occupies the preamble resources or not. In the contention-based random access, as various users select preambles from the same preamble resources in the process of attempting to establish the uplink connection, there may be multiple users choosing the same preamble to transmit to the base station. A conflict resolution mechanism is an important research direction in random access. How to reduce the conflict probability and how to quickly solve the conflicts that have occurred are the key indicators affecting the performance of random access.

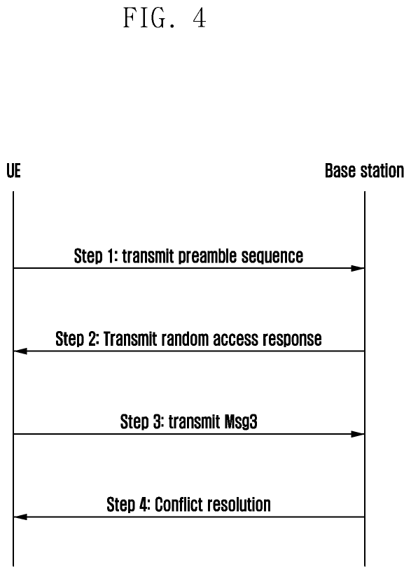

The contention-based random access process in LTE-A is divided into four steps, as shown in FIG. 4.

FIG. 4 is a schematic diagram of an example random access process according to an embodiment of the disclosure.

In the first step, the user randomly selects a preamble from a preamble resource pool, and transmits the preamble to the base station. The base station performs correlation detection on a received signal, thereby identifying the preamble transmitted by the user. In the second step, the base station transmits a random access response (RAR) to the user, including a random access preamble identifier, a timing advance instruction determined according to a time delay estimation between the user and the base station, a temporary cell-radio network temporary identifier (C-RNTI), and time-frequency resources allocated for the next uplink transmission of the user. In the third step, a third message (message 3, Msg3) is transmitted by the user to the base station according to the information in the RAR. The Msg3 includes information such as a user terminal identifier and an RRC connection request, wherein the user terminal identifier is unique to the user and is used for resolving conflicts. In the fourth step, a conflict resolution identifier is transmitted by the base station to the user, including an identifier of a winning user terminal in conflict resolution. After its own identifier is detected, the user upgrades the temporary C-RNTI to C-RNTI, and transmits an acknowledgment (ACK) signal to the base station to complete the random access process, and waits for the scheduling of the base station. Otherwise, the user will start a new random access process after a delay of time.

For the contention-free random access process, as the base station has known the user identifier, a preamble can be allocated to the user. Therefore, before transmitting the preamble, the user can use the allocated preamble, instead of randomly choosing the preamble. The base station, after detecting the allocated preamble, may transmit a corresponding random access response, which includes the information such as timing advance and uplink resource allocation. The user, after receiving the random access response, considers that the uplink synchronization has been completed and waits for the further scheduling of the base station. Therefore, the contention-free random access process only includes two steps: step one is to transmit the preamble, and step two is to transmit the random access response.

The random access process in the LTE is suitable for the following scenarios:
1. Initial access in RRC_IDLE;
2. Reestablishment of RRC connection;
3. Cell switch;
4. Downlink data arriving in an RRC connected state and requesting a random access process (when the uplink is asynchronous);
5. Uplink data arriving in an RRC connected state and requesting a random access process (when the uplink is asynchronous, or no resources in physical uplink control channel (PUCCH) resources are allocated to a scheduling request);
6. Positioning.

In some network systems, for example, in a 5G NR system, because a new frequency band (e.g., FR2) is enabled and power is limited, the problem of insufficient uplink coverage of random access may occur. Therefore, how to improve an uplink coverage capacity of a random access signal is a problem required to be solved.

According to embodiments of the disclosure, a method performed by user equipment (UE) in a wireless communication system is provided to solve at least one of the above problems. In addition, the method provided by the embodiments of the disclosure may also be used to solve other technical problems which are not explicitly mentioned herein, but can be solved according to the essence of the method.

Throughout the description herein, it may be understood that random access attempt can be understood as a physical random access channel (PRACH) transmission, and these two expressions or similar expressions (e.g., preamble transmission, etc.) can be used interchangeably and express basically the same meaning. In addition, according to the number of PRACHs that can be transmitted in a random access attempt, the PRACH transmission may be called a single PRACH transmission, or multiple PRACH transmissions. It may be understood that in this situation, the number of PRACH transmissions and the number of PRACH occasions (RO) can be used interchangeably.

Specifically, if the configured number of PRACH transmissions is 1 for a random access attempt, i.e., one PRACH may be transmitted in a random access attempt, or a random access attempt corresponds to one RO, then the PRACH transmission in this random access attempt is called single PRACH transmission. If the configured number of PRACH transmissions is greater than 1 (e.g., the configured number of PRACH transmissions is 2, 4, 8 and other integer) for a random access attempt, the PRACH transmission in this random access attempt is called multiple PRACH transmissions. In the following description, for the convenience of description or according to the description habit, in some places, multiple PRACH transmissions are described as multiple random access transmissions, or number of multiple PRACH transmissions are described as the number of times of PRACH transmissions, which should not be understood as inconsistent.

In addition, in order to avoid redundancy of description, the number of times of PRACH transmissions corresponding to/associated with a random access attempt is simply described as the number of times of PRACH transmissions in the following description.

A method according to the embodiments of the disclosure includes: receiving, by UE, configuration information related to random access from a base station. In this configuration information, the base station may configure the UE with information for indicating whether the random access attempt corresponds to a single PRACH transmission or multiple PRACH transmissions, or configure the UE with information for indicating one or more numbers of PRACH transmission to which a random access attempt may correspond (or called “the number of times”, which is described as N1, N2, . . . , Nm in the following, i.e., in a random access attempt, N1 PRACHs may be transmitted, or N2 PRACHs may be transmitted, or Nm PRACHs may be transmitted), or configure the UE with information indicating the number of possible values of the number (or the number of times) of PRACH transmissions to which a random access attempt may correspond (which is described as m in the following, i.e., the number/the number of times of PRACH transmissions may have m different values, which are expressed as Nm1, Nm2, . . . , Nmm).

According to the received configuration information, the UE may select or determine the number of PRACH transmissions associated with a random access attempt. In an implementation, the UE, based on a measurement result of a downlink signal, may select the number of PRACH transmissions adapted to the signal quality corresponding to the measurement result, making the selected number of PRACH transmissions well adapted to the current wireless communication conditions, and thus making the uplink coverage capacity of PRACH transmitted by the random access attempt adapted to the current wireless communication conditions.

Correspondingly, in an implementation, different ranges of the measurement result of the downlink signal corresponding to different values of the number of the PRACH transmissions can be configured. For example, when the measurement result is less than a first signal quality threshold, a first value of the number of PRACHs is selected, for example, the number of PRACH is determined as 8, that is, the number of times of multiple PRACH transmissions is 8. When the measurement result is between the first signal quality threshold and a second signal quality threshold, a second value of the number of PRACHs is selected, for example, the number of PRACHs is determined as 4, that is, the number of times of multiple PRACH transmissions is 4. When the measurement result is between the second signal quality threshold and a third signal quality threshold, a third value of the number of PRACHs is selected, for example, the number of PRACHs is determined as 2, that is, the number of times of multiple PRACH transmissions is 2. When the measurement result is greater than the third signal quality threshold, a fourth value of the number of PRACHs is selected, for example, the number of PRACHs is determined as 1, that is, the single PRACH transmission is performed.

According to the method provided by the embodiments of the disclosure, in a case that the configuration information related to the random access received by the UE from the base station includes information related to multiple values of the number of times of PRACH transmissions (i.e., the configuration information configures the UE with different numbers of times of multiple PRACH transmissions), the configuration information may also include power configuration information corresponding to different numbers of times. The power configuration information may include at least one of: an initial power value (e.g., initial power of preamble transmission), a pathloss compensation coefficient alpha, and a power ramping step.

In an implementation, different numbers of times of PRACH transmissions correspond to the same power configuration information. In another implementation, the power configuration information is specific to the number of times of PRACH transmissions, that is, different numbers of times of PRACH transmissions correspond to different power configuration information.

According to the method provided by the embodiments of the disclosure, the configuration information related to the random access received by the UE from the base station further includes a maximum value of the number of times of PRACH transmissions (or called the maximum number of times of preamble transmission). Based on the maximum value, the UE may switch between different numbers of times of PRACH transmissions.

For example, the configuration information related to the random access received by the UE from the base station configures the UE with a value set {1,2,4} of the number of times of PRACH transmissions, and configures the maximum number of times of preamble transmission as 10. By measuring its own channel condition, the UE determines to use the number of times of PRACH transmissions N=2 for random access attempt, that is, to transmit two PRACHs (or two preambles) in a random access attempt. Whenever correct feedback for two transmitted PRACHs is not received in a random access response (RAR) window after transmitting a random attempt, a preamble transmission counter is increased by the number of times of PRACH transmissions currently used, that is, the preamble transmission counter is increased by 2. In an instance, an initial value of the preamble transmission counter is 0. When the value of the preamble transmission counter reaches the configured maximum number of times of preamble transmissions, and the preamble transmission counter is greater than or equal to 10 in this example (e.g., when five random access attempts each associated with two PRACH transmissions are performed), if the number of times of PRACH transmissions currently used has not arrived the maximum value in the configured value set of the number of times of PRACH transmissions for the UE (the maximum value of the number of times of PRACH transmissions in this example is 4), the UE uses the next value in the configured value set of the number of times of PRACH transmissions that is greater than the value of the number of times of PRACH transmissions currently used. In this example, the number of times of PRACH transmissions N=4 is then used for random access attempt, and the preamble transmission counter is reset as 0.

After the UE performs three random access attempts with the number of times of PRACH transmissions N=4, the value of the preamble transmission counter is 12, which is greater than the configured maximum number of times of preamble transmissions 10, and at this time, the number of times of PRACH transmissions N=4 used by the UE has arrived the maximum value ₄ in the configured value set {1,2,4} of the number of times of PRACH transmissions, so the UE stops performing random access attempt and reports a random access problem.

In another implementation, different values of the number of times of PRACH transmissions correspond to different maximum number of times of preamble transmissions, the maximum number of times of preamble transmissions corresponding to each of the different values is independently configured, or obtained according to the configured maximum number of times of preamble transmissions and the number of different values of the number of times of PRACH transmissions.

In an example, in the configuration information related to the random access, the base station configures the UE with multiple values of PRACH transmissions and the maximum number of times of preamble transmissions corresponding to each of the multiple values, for example, the base station configures the UE with multiple values {1, 2, 4} and corresponding maximum number of times of preamble transmissions {10, 5, 3}.

In another example, in the configuration information related to random access, the base station configures the UE with multiple values of PRACH transmissions and a maximum number of times of preamble transmissions, the UE obtains the maximum number of times of preamble transmissions corresponding to each of the values of the number of times of PRACH transmissions by rounding a ratio of the maximum number of times of preamble transmissions configured by the base station to the number of values of the number of times of PRACH transmissions. For example, the base station configures the UE with multiple values {1, 2, 4} and the maximum number of times of preamble transmission 10, then the UE, according to the configured maximum number of times of preamble transmissions 10 and the number of values 3, rounds up to get 4, or rounds down to get 3, which is used as the maximum number of times of preamble transmissions corresponding to each of values of the number of times of PRACH transmissions.

According to the method provided by the embodiments of the disclosure, the configuration information related to random access received by the UE from the base station further includes the maximum number of times of random access attempts. Based on the maximum number of times, the UE may switch between different number of times of PRACH transmissions. A switch mode of the UE between different number of times of PRACH transmissions is similar to the method described above with reference to the maximum number of times of preamble transmissions, except that whenever the corresponding feedback is not received in the RAR window after the random access attempt, the value of the PRACH attempt counter is increased by 1, and the switch between different number of times of PRACH transmissions is performed according to whether the value of the PRACH attempt counter reaches the configured maximum number of times of random access attempts and whether the number of times of PRACH transmissions currently used reaches the maximum value in the values of the configured number of times of PRACH transmissions. Similarly, for different values of the number of times of PRACH transmissions, different maximum number of times of random access attempts can be configured separately, or the maximum number of times of random access attempts corresponding to different values of the number of times of PRACH transmissions can be obtained by rounding a ratio of the configured maximum number of times of random access attempts to the number of the different values, and different number of times of PRACH transmissions can be switched according to the maximum number of times of random access attempts corresponding to the different values. The specific details are similar to those described above with reference to the maximum number of times of preamble transmissions, and are not repeated here.

In an implementation, when the number of times of PRACH transmissions used by the UE for a random access attempt is switched compared with the previous random access attempt, a preamble power ramping counter may remain unchanged, while when the UE makes a random access attempt using the same number of times of PRACH transmissions as the previous random access attempt, the preamble power ramping counter may be increased by 1.

In another implementation, when the number of times of PRACH transmissions used by the UE for a random access attempt compared with the number of times of PRACH transmissions used for the previous random access attempt, an equivalently increased power value is not greater than a preamble power ramping step, the preamble ramping counter is increased by 1; otherwise, the preamble ramping counter remains unchanged.

In an implementation, when the times of PRACH transmissions used by the UE for a random access attempt compared with the times of PRACH transmissions used for the previous random access attempt, a difference between the equivalently increased power value and the preamble power ramping step is not greater than a certain threshold, the preamble ramping counter is increased by 1; otherwise, the preamble ramping counter remains unchanged.

It should be understood that the number of times of PRACH transmissions used in a random access attempt mentioned in above description may be the configured number of times of PRACH transmissions or the number of times of PRACH transmissions actually performed by the UE.

In an implementation, when the number of times of PRACH transmissions actually performed by the UE in a random access attempt is less than or equal to the number of times of PRACH transmissions actually performed in the previous random access attempt, the preamble ramping counter is increased by 1; otherwise, the preamble ramping counter remains unchanged.

According to the method provided by the embodiments of the disclosure, one or more PRACH transmissions corresponding to the random access attempt to be performed by the UE may not all be transmitted. Under some situations, some or all of the one or more PRACH transmissions may be cancelled.

In an implementation, if the total power of uplink transmissions by the UE on a serving cell in a certain frequency range exceeds the maximum transmission power in a certain transmission occasion, the UE allocates power to each uplink transmission according to the power allocation priority. For example, the power allocation priority of a single PRACH transmission on a primary cell (PCell) may be set to the highest, and the priority of the single PRACH transmission on the serving cell other than PCell may be set to be lower than that of any one of multiple PRACH transmissions on the PCell and higher than that of any one of multiple PRACH transmissions on the serving cell other than PCell.

In an implementation, if a symbol on the random access occasion (RO) is indicated to be flexible, the PRACH transmission on the RO is canceled.

In an implementation, if the PRACH transmission on one RO among multiple ROs associated with the random access attempt is canceled, the PRACH transmissions on the ROs after this RO and/or the ROs before this RO are also canceled.

In an implementation, if the PRACH transmissions on two ROs among the multiple ROs associated with the random access attempt are canceled, the PRACH transmissions on the ROs between the two ROs are also canceled.

In an implementation, if the number of ROs on which the PRACH transmissions have not been canceled among multiple ROs associated with the random access attempt is less than or equal to the number of times of PRACH transmissions corresponding to the previous random access attempt (configured number of times of PRACH transmissions or actual number of times of PRACH transmissions), the PRACH transmissions on all ROs associated with the random access attempt are canceled.

In an implementation, if the number of ROs on which the PRACH transmissions have not been canceled among multiple ROs associated with the random access attempt is less than or equal to the used or configured number of times of PRACH transmissions before switching to the number of times of PRACH transmissions corresponding to the random access attempt (configured number of times of PRACH transmissions or actual number of times of PRACH transmissions), the PRACH transmissions on all ROs associated with the random access attempt are canceled.

According to the method provided by the embodiments of the disclosure, in a case that the UE cancels all or part of PRACH transmissions on the ROs associated with a random access attempt, a physical layer (layer 1) of the UE notifies an upper layer (or a higher layer) to suspend a power ramping counter, and/or notifies the number of the transmitted PRACHs to the higher layer.

According to the method provided by the embodiments of the disclosure, in a case that the number of PRACH transmissions canceled on the RO associated with the random access attempt is greater than a certain threshold, the physical layer (layer 1) of the UE notifies the upper layer (or the higher layer) to suspend the preamble transmission counter or the random access attempt counter, or notifies to decrease the preamble transmission counter by the number of canceled PRACH transmissions and/or to decrease the random access attempt counter by 1.

1. According to the method provided by the embodiments of the disclosure, the UE, according to the selected random access occasion group (multiple random access occasions for multiple random access transmissions), calculates a RA-RNTI value for CRC scrambling used to search for the corresponding PDCCH fed back by the base station. A calculation formula of the RA-RNTI is as follows:

$$RA - RNTI = 1 + s\_id + 14 \times t\_id + 14 \times 80 \times f\_id + 14 \times 80 \times 8 \times ul\_carrier \_id$$

Wherein, for single PRACH transmission, s_id is an index of a first OFDM symbol of the PRACH occasion (0≤s_id<14). For multiple PRACH transmissions, s_id is an index of the second/last OFDM symbol of the x(x=[N/2])-th PRACH occasion in a RO group of the number of PRACH transmissions N (e.g., 2, 4, 8) corresponding to the random access attempt (0≤s_id<14).

The embodiments of the application are described in detail below. In the following description, the key point of the disclosure is mainly described for random access time domain related configuration information. The technical details described below can also be applied to the solution that the corresponding information or fields are included in random access frequency domain related configuration information. In addition, in the following description, in order to be concise and avoid redundancy, the method is mainly described from the perspective of the UE, and the network-side device that interacts with the UE and performs corresponding operations, such as the base station, is omitted. Therefore, the technical solution capable of obtaining a corresponding operation of the base station according to the description of the disclosure is also within the scope of the application.

In an implementation of the disclosure, a method for determining random access resource configuration is introduced, which is beneficial when N preambles are transmitted in a random access attempt (N is a positive integer greater than 1, e.g., N=2, 4, 8), especially when M optional values of the number of times of preambles are configured in a network, for example, there are m (0<m<M) levels of values of N, which are expressed as N₁, N₂ . . . , Nₘ, where N₁, N₂ . . . , Nₘ are selected from a value set {2,4,8} or {1, 2,4,8}, the first level of value of N corresponds to N₁, the second level of value of N corresponds to N₂, and so on.

In the disclosure, the expressions “transmitting one or more preambles” and “transmitting one or more random access channels (PRACH)” can be used interchangeably. In a wireless network system, UE may perform random access for various purposes (e.g., initial access to the system, obtaining uplink synchronization information, etc.). The performing of random access requires the UE to determine available random access resources, and the specific operation includes at least one of:

Receiving random access related resource configuration information, including at least one of:

Random access time domain related configuration information, including at least one of:

Random access configuration index, indicating a random access preamble format, and/or a random access configuration period, and/or a time unit index of the random access on a certain time length (e.g., a certain time length is 10 ms, the time unit index is slot 1, 4, 7), and/or the number of random access occasions (ROs) in a time unit, and/or starting position of the time unit, and/or the number of occupied time units.

The number N of random access preambles that can be transmitted, and/or the number N of random access channels that can be transmitted, and/or the number N of random access occasions (RO) that can be used for transmitting preambles in a random access attempt, where a random access attempt may be replaced by an associated or mapped SSB, N is a positive integer, which may be 1, and/or 2, and/or 4, and/or 8, or other positive integers greater than 1.

Wherein, a method for determining N ROs (N ROs is expressed as a RO group) includes at least one of:
the determination of the RO group is operated within a certain period of time, which, take an association pattern period of SSB-RO as an example, can be replaced by or extended to other possible periods of time within the certain period of time, i.e., in the determined association pattern period of SSB-RO, the UE determines the RO group according to W ROs in a time domain mapped by an SSB and a determined value of N, specifically including at least one of:
according to a descending order (or ascending order) of time, every N ROs among the W ROs is determined as each RO group in turn;
all RO groups in one determined association pattern period of the SSB-RO are RO group patterns;
each SSB correspond to the same number of RO group patterns;
different RO groups patterns in frequency domain are the same;
when there are multiple different values of N,
the multiple different values of N may share the ROs, in this case, different values of N are correspondingly mapped according to different preambles and/or preamble groups; and/or
the multiple different values of N do not share the ROs, in this case, ROs correspond to different values of N according to the number (and/or index) of ROs in the frequency domain; for example, ROs correspond to different values of N arranged in the descending order (or ascending order) in the descending order (or ascending order) of the RO indexes in the frequency domain; for example, if there are four ROs in the frequency domain, and configured values of N are 2, 4 and 8, the RO index 0 in the frequency domain corresponds to N=2, the RO index 1 in the frequency domain corresponds to N=4, and the RO index 2 in the frequency domain corresponds to N=8; as the determined RO group pattern is for the time domain, the different RO group patterns in frequency domain may correspond to different values of N, for example, when it is determined N=2, [W/2] RO groups are determined in turn; when N=4, [W/4] RO groups are determined in turn, and so on; [X] is to perform round down operation on X, and this method is beneficial to the effective use of RO patterns configured in the frequency domain; and/or
the multiple different values of N do not share the ROs, in this case, the ROs obtained in different random access configurations correspond to different values of N, that is, different values of N have different PRACH configurations; and/or
RO groups corresponding to multiple different values of N are determined from the same starting point in an association pattern period of SSB-RO;
UE determines the RO group from the first association pattern period of SSB-RO starting from SFN0;
when the number of time units occupied by a RO group is greater than or not less than a fourth threshold, the RO group is discarded; otherwise, the RO group is reserved;
the RO group pattern in each of the association pattern periods of SSB-RO is the same, that is, the RO group pattern appears repeatedly;
ROs that are not grouped into a complete RO group and/or the preambles on the ROs in an association pattern period of SSB-RO are not used for multiple random access transmissions, that is, the ROs and/or preambles cannot be selected by UE that performs multiple PRACH transmissions;
the ROs may be replaced by valid ROs;
the RO group may be replaced by a valid RO group, and the valid RO group may be determined according to the following:
when the number of time units occupied by a RO group is not greater than or less than the fourth threshold, the RO group is a valid RO group; and otherwise, the RO group is an invalid RO group;
the number of time units occupied by a RO group is the number of time units occupied from the beginning of the first RO to the end of the last RO in the RO group, including interval time units between possibly discontinuous ROs; and/or
an incomplete RO group is an invalid RO group, and a complete RO group is a valid RO group;
the certain period of time includes at least one of:
mapping cycle of SSB-RO;
association period of SSB-RO;
association pattern period of SSB-RO;
PRACH configuration period
fixed time value, e.g., 10 ms
RO group pattern period, wherein the determined RO group pattern (including one or more RO groups) repeats in the RO group pattern period, and/or a RO group pattern period at least includes a RO group corresponding to (any one or all or the maximum of) configured value(s) of N; wherein:

The RO group pattern period may be one or more of the following periods of time:
mapping cycle of SSB-RO;
association period of SSB-RO;
association pattern period of SSB-RO;
PRACH configuration period;
fixed time value;
the certain period of time may be replaced by a certain number of RO groups or the time unit range occupied by the certain number of RO groups; wherein:
the certain number includes the maximum number and/or the nominal number of the RO groups; and/or
the certain number corresponds to (any one or all or the maximum of) configured value(s) of N.
m values of the number of times of preambles, for example, there are m (0<m<M, and M is a positive integer greater than 1) levels of values of N, which are expressed as N₁, N₂ . . . , Nₘ, where N₁, N₂ . . . , Nₘ are selected from a value set {2,4,8} or {1, 2,4,8} of the number of times of preamble transmission, the first level of value of N corresponds to N1, the second level of value of N corresponds to N2, and so on.

Alternatively, the number m of values of the times of preambles and the corresponding values of N of the times of preambles may be jointly configured, for example: configuring

| NumberofMultiPRACH CHOICE | |
|---|---|
| { | |
| m=1 | Nₘ₁ |
| m=2 | Nₘ₁, Nₘ₂ |
| m=3 | Nₘ₁, Nₘ₂, Nₘ₃ |
| m=4 | Nₘ₁, Nₘ₂, Nₘ₃, Nₘ₄ |

}

where Nₘ₁˜Nₘ₄ are values configured by a base station device, with a value range of {1, 2, 4,8}, and value sets {N₁, . . . , Nₘ} may be different for different m values. For example, Nₘ₂=N₂₂=2 when m=2 and Nₘ₂=N₃₂=4 when m=3 may be different; greater flexible configuration characteristics can be provided to the base station; and when multiple values of N are configured, that is, when m>1, the UE selects a value of N to be used through certain conditions, wherein the certain conditions include at least one of:
each value of N corresponds to an interval of downlink reference signal received power (DL-RSRP), and when the DL-RSRP measured by the UE falls into a corresponding interval (i.e., greater than (or not less than) a lower limit of the interval, but not greater than (or less than) an upper limit of the interval), the UE determines to use the value of N corresponding to the interval. The DL-RS includes SSB and/or channel state information (CSI)-RS/positioning RS (PRS), for example, m=2, N₂₁=2, N₂₂=4, the DL-RSRP interval corresponding to N₂₁ is [lower limit DL-RSRP1, upper limit DL-RSRP2], and the DL-RSRP interval corresponding to N₂₂ is [lower limit DL-RSRP3, upper limit DL-RSRP2], when the DL-RSRP value measured by the UE is less than DL-RSRP2 but greater than DL-RSRP1, the UE determines to use the value of N N₂₁=2; and alternatively, DL-RSRP3<DL-RSRP2<DL-RSRP1;
alternatively, the value of N is selected and determined according to RSRP only at an initialization stage of random access process, i.e., the operation of selecting value of N based on RSRP is performed only once during a random access process.

The maximum number of times of random access preamble transmissions preambleTransMax (preambleTransMax is a positive integer),
when the UE does not receive a feedback correctly in the RARwindow (including the PDCCH with a corresponding RA-RNTI is not detected, and/or there is no matched RAPID in the RAR in the corresponding PDCCH), the UE increases the PREAMBLE_TRANSMISSION_COUNTER by N, and the value of N is the number of times of transmissions that should be made and determined by UE or the number of times of transmissions actually made by UE for the latest random access attempt; when the PREAMBLE_TRANSMISSION_COUNTER is greater than preambleTransMax, the UE reports a random access problem, otherwise, the UE preforms random access resource selection for the purpose of re-performing random access transmission;
alternatively, when m values of N are configured, the maximum number of times of random access preamble transmissions for each value of N is separately configured, for example, each N is configured with corresponding preambleTransMax_Nₘ; alternatively, preambleTransMax_Nₘ=preambleTransMax/m; alternatively, preambleTransMax/m=[preambleTransMax/m], [X] denotes a rounding operation on X, which may be round up or round down. When PREAMBLE_TRANSMISSION_COUNTER is equal to or greater than preambleTransMax_Nₘ+1 and the current Nₘ is less than the maximum configured Nₘ value, the UE determines the next level of Nₘ value as the value of N to be used, that is, the switch between different number of times of multiple random accesses is performed; and/or the UE determines that PREAMBLE_TRANSMISSION_COUNTER is reset as 1, and/or performs random access resource selection for the purpose of re-performing random access transmission; otherwise, if the current Nₘ is equal to the maximum configured Nₘ value, the UE reports the random access problem; for example, m=2, N₂₁=2, N₂₂=4, preambleTransMax=12, preamble TransMax_Nₘ=preambleTransMax/m=6, UE selects N₂₁=2 for random access transmission; when PREAMBLE_TRANSMISSION_COUNTER is greater than or equal to preambleTransMax_Nₘ+1=7, the UE determines to perform random access transmission using N22=4, to switch to N22 from N21; PREAMBLE_TRANSMISSION_COUNTER is reset as 1;
alternatively, when N′=preamble TransMax-PREAMBLE_TRANSMISSION_COUNTER<N, the value of N is the number of times of transmissions that should be made and determined by UE in the latest random access attempt, the UE determines to use a N′ value as the value of the number of times for transmitting the random access preamble. Otherwise, the UE determines to use the value of N as the value of the number of times for re-transmitting the random access preamble.

The maximum number of times of random access attempts PRACHAttemptMax (PRACHAttemptMax is a positive integer),
the initial setting is that PRACH_ATTEMPT_COUNTER=1,
when the UE does not receive a feedback correctly in the RARwindow (including that the PDCCH with a corresponding RA-RNTI is not detected, and/or there is no matched RAPID in the RAR in the corresponding PDCCH), the UE increases the PREAMBLE_ATTEMPT_COUNTER by 1, when PRACH_ATTEMPT_COUNTER is equal to PRACHAttemptMax+1, the UE reports the random access problem, otherwise, the UE preforms random access resource selection for the purpose of re-performing random access transmission;
alternatively, PREAMBLE_TRANSMISSION_COUNTER=, Σᵢ₌₁^{PRACH_ATTEMPT_COUNTER} Nᵢ, Nᵢ denotes the (configured and/or actual) number of times of random access transmission determined for an i-th attempt, Σᵢ₌₁^{PRACH_ATTEMPT_COUNTER} Nᵢ denotes the accumulation of values of N of each of the attempts from the first time to the PRACH_ATTEMPT_COUNTER;
alternatively, when m values of N are configured, the maximum number of times of random access attempts for each value of N is separately configured, for example, each Nₘ is configured with corresponding PRACHAttemptMax_Nₘ; alternatively, PRACHAttemptMax_Nₘ=PRACHAttemptMax/m; alternatively, PRACHAttemptMax/m= [PRACHAttemptMax/m], [X] denotes a rounding operation on X, which may be round up or round down; when PRACH_ATTEMPT_COUNTER is equal to PRACHAttemptMax_Nₘ+1 and the current Nₘ is less than the maximum configured Nₘ value, the UE determines the next level of Nₘ value as the value of N to be used, that is, the switch between different number of times for multiple random accesses is performed; and/or the UE determines that PRACH_ATTEMPT_COUNTER is reset as 1, and/or performs random access resource select for the purpose of re-performing random access transmission; otherwise, if the current Nₘ is equal to the maximum configured Nₘ value, the UE reports the random access problem; for example, m=2, N₂₁=2, N₂₂=4, PRACHAttemptMax=12, PRACHAttemptMax_Nₘ=PRACHAttemptMax/m=6, UE selects N₂₁=2 for random access transmission; when PRACH_ATTEMPT_COUNTER=PRACHAttemptMax_Nₘ+1=7, the UE determines to perform random access transmission by using N₂₂=4, to switch to N₂₂ from N₂₁; PREAMBLE_ATTEMPT_COUNTER is reset as 1.

Alternatively, power related configuration information corresponding to each value of N, and the power related configuration information includes at least one of:
Preamble received power preambleReceivedTargetPower_N
Pathloss compensation coefficient alpha_N;
Power ramping step, PREAMBLE_POWER_RAMPING_STEP_N;
wherein, for example, different values of N correspond to the same power related configuration information, which may be the same one or multiple pieces of identical power related configuration information, for example, all configured values of N, e.g., m values of N correspond to the same preamble received power preambleReceivedTargetPower, and/or the same pathloss compensation coefficient alpha; and/or the same power ramping step PREAMBLE_POWER_RAMPING_STEP
when different number of times of multiple random accesses are switched, that is, the value of N before switch is N_{old} and the value of N after switch is N_{new}:
PREAMBLE_POWER_RAMPING_COUNTER remains unchanged, otherwise, PREAMBLE_POWER_RAMPING_COUNTER+1;
when 3*log 2 (N_{new}/N_{old}) is greater than or equal to PREAMBLE_POWER_RAMPING_STEP, PREAMBLE_POWER_RAMPING_COUNTER remains unchanged; otherwise, PREAMBLE_POWER_RAMPING_COUNTER+1;
vice versa, when 3*log 2 (N_{new}/N_{old}) is less than PREAMBLE_POWER_RAMPING_STEP, PREAMBLE_POWER_RAMPING_COUNTER+1; otherwise, PREAMBLE_POWER_RAMPING_COUNTER remains unchanged;
when 3*log 2 (N_{new}/N_{old})-PREAMBLE_POWER_RAMPING_STEP is greater than or equal to a first threshold, PREAMBLE_POWER_RAMPING_COUNTER remains unchanged; otherwise, PREAMBLE_POWER_RAMPING_COUNTER+1;
vice versa, when 3*log 2 (N_{new}/N_{old})—PREAMBLE_POWER_RAMPING_STEP is less than the first threshold, PREAMBLE_POWER_RAMPING_COUNTER+1; otherwise, PREAMBLE_POWER_RAMPING_COUNTER remains unchanged;
the above values of N, such as N_{new} and N_{old}, may be the configured value of number of times N determined by the UE or the actual number of times of transmissions made by the UE, such as N_{new}-actual and N_{old}-actual; when the actual number of times of transmissions made by the UE after the switch (or the configured number of times determined by the UE) is less than or equal to the actual number of times of transmissions made by the UE before the switch (or the configured number of times determined by the UE), PREAMBLE_POWER_RAMPING_COUNTER+1, otherwise, PREAMBLE_POWER_RAMPING_COUNTER remains unchanged; for example, the configured value of number of times N value may be N_{new}=4, N_{old}=2, N_{new-actual}=2, and N_{old-actual}=2. At this time, N_{new-actual} is equal to N_{old-actual}, then PREAMBLE_POWER_RAMPING_COUNTER+1;
vice versa, when the actual number of times of transmissions made by the UE after switch (or the configured number of times determined by the UE) is greater than the actual number of times of transmissions made by the UE before switch (or the configured number of times determined by the UE), PREAMBLE_POWER_RAMPING_COUNTER remains unchanged, otherwise, PREAMBLE_POWER_RAMPING_COUNTER+1;
wherein, PREAMBLE_POWER_RAMPING_STEP may be PREAMBLE_POWER_RAMPING_STEP_N, i.e., power ramping step specific to the value of N.
wherein, the SSB may be replaced by other downlink beam signals, including CSI-RS, PRS, tracking RS (TRS) and the like.

Random access frequency domain related configuration information, including at least one of:
a starting position of a frequency domain unit of a first RO in the frequency domain, including an absolute frequency value indication, and/or a gap frequency domain unit value relative to a frequency domain reference point;
the number of gap frequency domain units between adjacent ROs in the frequency domain;
the number N_RO_FDM of frequency-division multiplexed ROs at the same time, alternatively, the number of frequency-division multiplexed ROs may be within a frequency domain range, such as within a BWP, or within an RB set, or within other frequency domain units; where N_RO_FDM is a positive integer, which may be 1, and/or 2, and/or 4, and/or 8, or may be other positive integers greater than 1;
alternatively, when a random access attempt may transmit N random access preambles, where N is a positive integer and may be 1, and/or 2, and/or 4, and/or 8, or other positive integers greater than 1; the frequency domain positions of M random access occasions where the N random access preambles are located (where M is a positive integer, which may be 1, and/or 2, and/or 4, and/or 8, or other positive integers greater than 1, and/or M may be equal to N, that is, one random access preamble is transmitted on one RO; and/or M may be less than N, that is, multiple random access preambles are transmitted on one RO) can be determined according to at least one of the following ways:
the frequency unit starting positions of the M ROs are obtained by separate configuration, that is, each RO has its own frequency domain unit starting position;
the frequency unit starting positions of the M ROs are obtained according to a certain pattern rule;
the ROs may be replaced by valid ROs, or ROs mapped to SSB/CSI-RS, and/or ROs with associated physical uplink shared channel (PUSCH) resources.

N random access preambles are transmitted in a random access attempt according to the received random access related resource configuration information, and/or the determined value of N and the determined RO(s), i.e., the RO group; under certain conditions, the UE needs to cancel the transmission of part or all of the preambles, that is, according to the determined configured value of N, the UE may select a RO group with N ROs to perform a random access attempt with N preamble transmissions; however, according to certain conditions, X (X may be 1, or less than or equal to N) preamble transmissions on the N ROs may be canceled, and the Y=(N−X) preamble transmissions that are not canceled represent the number of times of actual preamble transmissions in the random access attempt; specifically comprising at least one of:
according to power allocation priority, PRACH transmissions on one or more ROs among the N preamble transmissions are canceled, wherein the power allocation priority includes: if a total UE transmit power for PUSCH or PUCCH or PRACH or sounding reference signal (SRS) transmissions on serving cells in a frequency range in a respective transmission occasion i would exceed P\hat{ }_CMAX (i), the UE allocates power to PUSCH/PUCCH/PRACH/SRS transmissions according to the following priority order (in descending order) so that the total UE transmit power for transmissions on serving cells in the frequency range is smaller than or equal to the transmit power \hat{P}_{CMAX} (i) for that frequency range in every symbol of transmission occasion i. The total UE transmit power in a symbol of a slot is defined as the sum of the linear values of UE transmit powers for PUSCH, PUCCH, PRACH, and SRS in the symbol of the slot.
   single PRACH transmission on the PCell
      PUCCH or PUSCH transmissions with larger priority index
Any one PRACH transmission of multiple PRACH transmission on the PCell;
   For PUCCH or PUSCH transmissions with same priority index
   PUCCH transmission with hybrid automatic repeat request acknowledgment (HARQ-ACK) information, and/or scheduling request (SR), and/or link recovery request (LRR), or PUSCH transmission with HARQ-ACK information of the priority index
   PUCCH transmission with CSI or PUSCH transmission with CSI
   PUSCH transmission without HARQ-ACK information of the priority index or CSI and, for Type-2 random access procedure, PUSCH transmission on the PCell
   SRS transmission, with aperiodic SRS having higher priority than semi-persistent and/or periodic SRS, or single PRACH transmission on a serving cell other than the PCell
Any one PRACH transmission of multiple PRACH transmission on a serving cell other than PCell;
PRACH transmission is canceled caused by detecting a situation of slot format indication (SFI), for example, if SFI indicates that a symbol on a corresponding RO is flexible, the PRACH transmission on the RO is canceled.

The UE may choose to cancel the PRACH transmission on the RO when the PRACH transmission on a RO and other PUSCH and/or PUCCH and/or SR are at the same slot or with an interval in the time domain less than or equal to a second threshold.

In the N times of PRACH transmissions performed on N ROs, if the PRACH transmission on the j-th (0<j≤N) RO among the N ROs is canceled,
the ROs after the j-th RO among the N ROs are also canceled, that is, the PRACHs on the j-th RO and ROs thereafter are all canceled; which is beneficial, for example, when the UE cancels the PRACH transmission on a certain RO for other uplink signals, it may actually take more time to switch or cannot guarantee the phase continuity and/or power consistence due to power adjustment, beam adjustment, radio frequency adjustment and other reasons, so the UE may not be able to well perform the PRACH transmission on other ROs after the j-th RO in time; or
the ROs before the j-th RO among the N ROs are also canceled, that is, the PRACHs on the j-th RO and ROs therebefore are all canceled; which is beneficial, for example, when the PRACH transmission on one RO is canceled due to the SFI indicates the OFDM symbol on the RO is flexible, since there is a high probability that a symbol before the OFDM symbol is also a flexible symbol or a downlink OFDM symbol, and there is a high probability that uplink PRACH transmission cannot be performed.

In the N times of PRACH transmissions performed on N ROs, when the PRACHs on the j1-th and j2-th (0<j1<j2≤N) ROs among the N ROs are canceled, the PRACH transmissions on the ROs between the j1-th and j2-th ROs are also canceled.

Alternatively, when Y is less than or equal to the previous or prior level of (configured and/or actual) number of times of PRACH transmissions, the UE cancels the PRACH transmissions on all N ROs.

When the UE cancels PRACH transmission on part or all of N ROs, Layer 1 (or physical layer) notifies the higher layers to suspend the power ramping counter, and/or the UE informs the higher layer of the number of transmitted PRACHs.

When the UE cancels the PRACH transmissions on all ROs (that is, X=N) and/or X ROs, and X is greater than (or not less than) a third threshold, Layer 1 (or physical layer) notifies the higher layer to suspend the preamble transmission counter and/or the random access attempt counter, or Layer 1 (or physical layer) notifies the higher layer to decrease the preamble transmission counter by one (or X, which is equivalent to decrease N when X=N) and/or the random access attempt counter by one.

After one or more or all of the preambles are transmitted, the UE may monitor the feedback from the base station (e.g., random access response, RAR and/or PDSCH with RAR, and/or PDCCH scheduling PDSCH with RAR); the CRC of the PDCCH related to RAR is scrambled by RA-RNTI; and when the UE employs multiple PRACH transmissions with the number of times of N, the calculation formula of the RA-RNTI may be:
the RA-RNTI associated with the PRACH occasion (or PRACH occasion group) for a single PRACH transmission or multiple PRACH transmissions for transmitting random access preambles is calculated as follows:

RA-RNTI=1+s_id+14×t_id+14×80×f_id+14×80×8×ul_carrier_id, wherein
for single PRACH transmission, s_id is an index of the first OFDM symbol of the PRACH occasion (0≤s_id<14);
for multiple PRACH transmissions with number of times of N, s_id is the index of the second/last OFDM symbol of the w-th PRACH occasion among N PRACH occasions (0≤s_id<14), a valuing method of the w includes at least one of:
by means of table query, the correspondence between value of N and value of w may be one of the following cases:

| | case 1 | case 2 | case 3 | case 4 | case 5 | case 6 | case 7 | case 8 |
|---|---|---|---|---|---|---|---|---|
| N | w | | | | | | | |
| 2 | 2 | 2 | 1 | 1 | 1 | 1 | 2 | 2 |
| 4 | 3 | 3 | 2 | 2 | 4 | 4 | 1 | 1 |
| 8 | 1 | 4 | 4 | 8 | 2 | 6 | 3 | 7 |

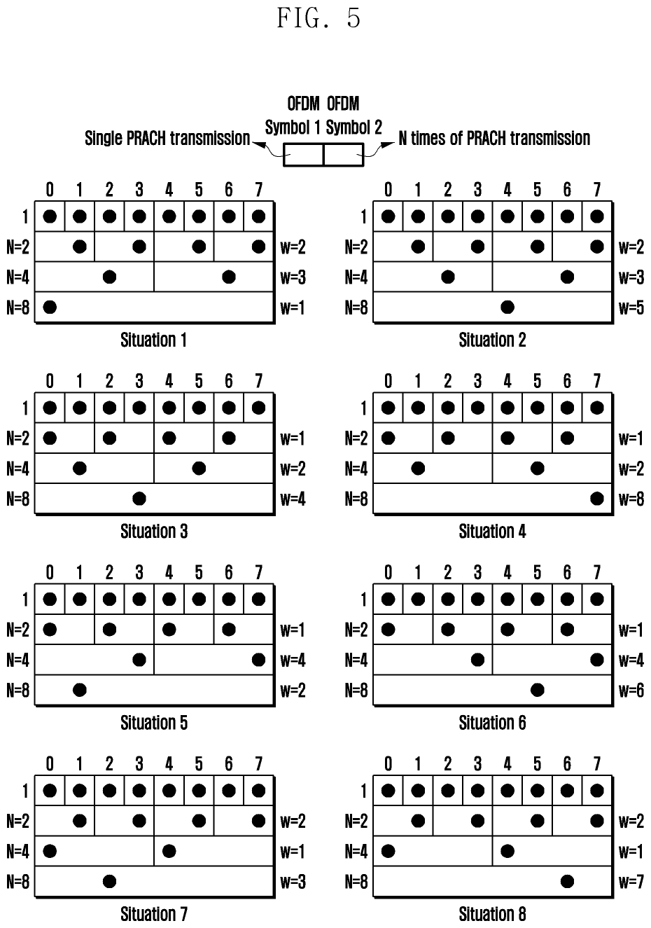

FIG. 5 is a schematic diagram of a corresponding situation of a value of N and a value of w according to an embodiment of the disclosure.

Referring to FIG. 5, PRACH format A1 (one RO occupies two OFDM symbols) is used as an example to show the correspondence between value of N and value of w. The black dots in FIG. 5 schematically shows positions of the w-th ROS; the calculation of s_id by choosing the second or last OFDM symbol in the RO for multiple PRACH transmissions may distinguish RA-RNTI for all multiple PRACH transmissions with different values of N from that for single PRACH transmission, especially when the RO resources for the N times of PRACH transmissions and for the single PRACH transmission are shared. The benefit of the designed value of w is that when the RO resources for the N times of PRACH transmissions are shared with the RO resources for the single PRACH transmission and/or all share the RO resources for the single PRACH transmission, the UE that has selected a different number of times of PRACH transmissions cannot misread the feedback corresponding to other numbers of times of RO through the calculation of RA-RNTI. For example, the RA-RNTI calculated by the ROs corresponding to the four times of PRACH transmissions is different from the RA-RNTI calculated by the ROs corresponding to two times of PRACH transmissions, the transmitted PDCCH cannot be detected by the UE that transmits four times of random accesses when the base station feeds back for the detected two times of random accesses, thus avoiding the UE that transmits four times of random accesses from performing useless PDDCH detection and/or subsequent PDSCH detection and decoding, or even false stagnant RAR search; the sharing may be full sharing or partial sharing;
w=N/2, that is, s_id is the index of the second/last OFDM symbol of the (N/2)-th PRACH occasion (0≤s_id<14) among the N PRACH occasions (N∈{2,4,8}) for multiple PRACH transmissions with the number of times of N; in addition to the above, the benefits of this method also include the intuitive representation of the value relationship between N and w through a simple formula calculation;
alternatively, w=[N/2], [x] means to perform round operation on x, which may be round up or round down; that is, s_id is the index of the second/last OFDM symbol of the ceil (N/2)-th PRACH occasion (0≤s_id<14) among N PRACH occasions (N∈{2,4,8} or N∈{1,2,4,8}) for multiple PRACH transmissions with the number of times of N and/or single PRACH transmission; in addition to the above, the benefits of this method also include the ability to deal with single PRACH transmission and multiple PRACH transmissions at the same time.
t_id is the index of the first slot of the PRACH occasion in a system frame (0≤t_id<80), where the subcarrier spacing to determine t_id is based on the value of u specified in clause 5.3.2 in TS 38.211 [8] for μ={0, 1, 2, 3}, and for μ={5, 6}, t_id is the index of the 120 KHz slot in a system frame that contains the PRACH occasion (0≤t_id<80),
f_id is the index of the PRACH occasion in the frequency domain (0≤f_id<8), and
ul_carrier_id is the UL carrier used for Random Access Preamble transmission (0 for NUL carrier, and 1 for SUL carrier).

In another implementation of the disclosure, a method for determining resource configuration for small data transmission (SDT) is also provided, which, in the SDT, is specifically a method for determining an association period and/or association pattern period from a corresponding downlink beam reference signal (with SSB as an example for description, which can be replaced as other signals, such as CSI-RS, PRS) to CG-PUSCH for some values of configuration period of configured grant-PUSCH (CG-PUSCH) of SDT.

Starting from a reference time point, the minimum number of configuration periods of CG-PUSCH used to map N SSB indexes to valid PUSCH occasions and its associated demodulation RS (DMRS) resources are taken as an association period, in which N SSB indexes can be completely mapped to the valid PUSCH occasions and its associated DMRS resources at least once. The configuration period of the CG-PUSCH is determined by receiving the configuration of the network device, and/or, a period including one or more association periods is determined as an association pattern period, wherein the association pattern from SSB to PUSCH occasions and its associated DMRS resources repeatedly occurs with the association pattern period.

Preferably, when size of the configuration period of the CG-PUSCH satisfies certain conditions, the association period or the association pattern period is the number of the preset number of CG-PUSCH configuration periods, for example, one CG-PUSCH configuration period. The advantage is that the association period and/or the association pattern period can be ensured when the CG-PUSCH configuration period is already large, and the UE does not need to calculate the period of SSB-CG-PUSCH within a very long time, such as an integer multiple of CG-PUSCH configuration periods. The certain condition includes one or more of: the configuration period of CG-PUSCH is greater than (not less than) 640 ms; preferably, when the period of the CG-PUSCH is {1280, 2560, 5120, 10240, 61440, 122880, 307200, 604160, 1208320, 1802240, 3604480} ms; in addition, a table format as follows may also be used:

| Configuration period of CG- | Association period (the number of |
|---|---|
| PUSCH (ms) | configuration periods of CG-PUSCH) |
| 5 | {1, 2, 4, 8, 16, 32, 64, 128} |
| 8 | {1, 2, 4, 5, 8, 10, 16, 20, 40, 80} |
| 10 | {1, 2, 4, 8, 16, 32, 64} |
| 16 | {1, 2, 4, 5, 8, 10, 20, 40} |
| 20 | {1, 2, 4, 8, 16, 32} |
| 32 | {1, 2, 4, 5, 10, 20} |
| 40 | {1, 2, 4, 8, 16} |
| 64 | {1, 2, 5, 10} |
| 80 | {1, 2, 4, 8} |
| 128 | {1, 5} |
| 160 | {1, 2, 4} |
| 320 | {1, 2} |
| 640, 1280, 2560, 5120, | {1} |
| 10240, 61440, 122880, | |
| 307200, 604160, 1208320, | |
| 1802240, 3604480 | |

The configuration period of the CG-PUSCH is greater than (not less than) one frame length, i.e., 1024 SFNs, that is, 10240 ms; preferably, there may be one or more of: when the period of the CG-PUSCH is {10240, 61440, 122880, 307200, 604160, 1208320, 1802240, 3604480} ms; in addition, a table format as follows may also be used:

| Configuration period of CG- | Association period (the number of |
|---|---|
| PUSCH (ms) | configuration periods of CG-PUSCH) |
| 5 | {1, 2, 4, 8, 16, 32, 64, 128} |
| 8 | {1, 2, 4, 5, 8, 10, 16, 20, 40, 80} |
| 10 | {1, 2, 4, 8, 16, 32, 64} |
| 16 | {1, 2, 4, 5, 8, 10, 20, 40} |
| 20 | {1, 2, 4, 8, 16, 32} |
| 32 | {1, 2, 4, 5, 10, 20} |
| 40 | {1, 2, 4, 8, 16} |
| 64 | {1, 2, 5, 10} |
| 80 | {1, 2, 4, 8} |
| 128 | {1, 5} |
| 160 | {1, 2, 4} |
| 320 | {1, 2} |
| 640, 10240, 61440, 122880, | {1} |
| 307200, 604160, 1208320, | |
| 1802240, 3604480 | |

Preferably, when the period of the CG-PUSCH is {61440, 122880, 307200, 604160, 1208320, 1802240, 3604480} ms; in addition, a table format as follows may also be used:

| Configuration period of CG- | Association period (the number of |
|---|---|
| PUSCH (ms) | configuration periods of CG-PUSCH) |
| 5 | {1, 2, 4, 8, 16, 32, 64, 128} |
| 8 | {1, 2, 4, 5, 8, 10, 16, 20, 40, 80} |
| 10 | {1, 2, 4, 8, 16, 32, 64} |
| 16 | {1, 2, 4, 5, 8, 10, 20, 40} |
| 20 | {1, 2, 4, 8, 16, 32} |
| 32 | {1, 2, 4, 5, 10, 20} |
| 40 | {1, 2, 4, 8, 16} |
| 64 | {1, 2, 5, 10} |
| 80 | {1, 2, 4, 8} |
| 128 | {1, 5} |
| 160 | {1, 2, 4} |
| 320 | {1, 2} |
| 640, 61440, 122880, 307200, | {1} |
| 604160, 1208320, | |
| 1802240, 3604480 | |

In addition, it may include a period less than (not greater than) 10240 ms, such as 1280, 2560 and 5120 ms; in an existing way, a given CG-PUSCH period can be divided by a CG-PUSCH period value which is less than the given CG-PUSCH period value, and an obtained integer value can be added to the association period corresponding to the divided CG-PUSCH period value.

Wherein, the reference time point includes one or more of: conventional SFN 0 received configured reference time point, preferably, when the configuration period of the CG-PUSCH satisfies the certain conditions, the reference time point is an index starting point of the second SFN, e.g., the second SFN0, the value range of the second SFN is 0, 1, 2, . . . , X, X is a positive integer greater than (not less than) 360447 (3604480-1), for example, X=360447, or X=1024*1024−1=1048575, or X=2048*2048-1=4194303.

In the disclosure, the mapping and association may be mutually replaced with each other.

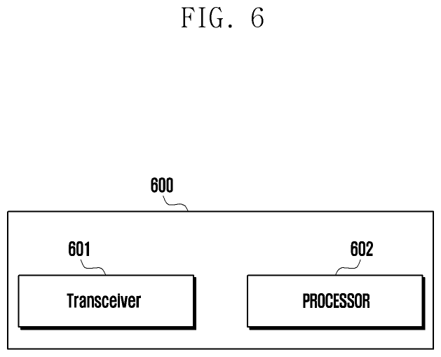

FIG. 6 is a schematic diagram of an example wireless device according to an embodiment of the disclosure.

Referring to FIG. 6, a communication device 600 is provided by the embodiments of the disclosure. The communication device includes a transceiver 601, and a controller/processor 602. The transceiver 601 is configured to transmit and/or receive data or signals. The controller/processor 602 is configured to perform control, so that the communication device performs the method or operation according to at least one aspect in various aspects of the embodiments of the disclosure. Alternatively, the communication device may also include memory (not shown). A computer executable instruction may be stored on the memory. When the instruction is performed by the controller/processor 602, the communication device may perform at least one method corresponding to each embodiment of the disclosure.

It may be understood by those skilled in the art that the disclosure includes devices for performing one or more of the operations described in this application. These devices may be specially designed and manufactured for required purposes, or may include known devices in general-purpose computers. These devices have computer programs stored therein, which are selectively activated or reconfigured. Such computer programs may be stored in a device (e.g., a computer) readable medium or in any type of medium suitable for storing electronic instructions and respectively coupled to a bus. The computer readable medium includes, but is not limited to, any type of disk (including floppy disk, hard disk, optical disk, compact disc (CD)-ROM, and magneto-optical disk), a ROM, a RAM, an erasable programmable ROM (EPROM), an electrically EPROM (EEPROM), flash memory, a magnetic card, or optical card. This is to say, the readable medium includes any medium in which information is stored or transmitted by a device (e.g., a computer) in a readable form.

It may be understood by those skilled in the art that the computer instructions may be used to implement each block in these structural diagrams and/or block diagrams and/or flowcharts as well as a combination of blocks in these structural diagrams and/or block diagrams and/or flowcharts. It may be understood by those skilled in the art that these computer program instructions may be provided to general-purpose computers, special-purpose computers or other processors of programmable data processing means to be implemented, thus performing solutions designated in a block or blocks of the structure diagrams and/or block diagrams and/or flow diagrams by computers or other processors of programmable data processing means.

It may be understood by those skilled in the art that the operations, methods, steps in the flows, measures and solutions already discussed in the disclosure may be alternated, changed, combined or deleted. Further, the operations, methods, other steps in the flows, measures and solutions already discussed in the disclosure may also be alternated, changed, rearranged, decomposed, combined or deleted. Further, prior arts having the operations, methods, the steps in the flows, measures and solutions already discussed in the disclosure may also be alternated, changed, rearranged, decomposed, combined or deleted.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by user equipment (UE) in a wireless communication system, the method comprising:
receiving configuration information related to random access, wherein the configuration information comprises at least one of first information on a number of physical random access channel (PRACH) transmissions associated with a random access attempt, or a maximum value related to the random access; and
transmitting a first number of PRACHs, wherein the first number is determined based on the maximum value or the first information.

2. The method according to claim 1,
wherein the first information comprises a set of numbers of PRACH transmissions, or
wherein the first information comprises a number of numeral values in the set of numbers of PRACH transmissions, the numeral values in the set corresponding to one or more numbers of PRACH transmissions.

3. The method according to claim 1, wherein the maximum value is a maximum value of a number of times of PRACH transmissions, or a maximum value of a number of times of random access attempts.

4. The method according to claim 3, wherein the maximum value comprises:
a maximum value corresponding to each of numeral values in the numbers of PRACH transmissions, or
by rounding a ratio of the maximum value to the number of the numbers of PRACH transmissions, a maximum value related to random access which corresponds to each numeral value of the numbers of PRACH transmissions is obtained.

5. The method according to claim 1, wherein the transmitting of the first number of PRACHs comprises:
in case that the first number of PRACH transmissions associated with a current random access attempt is less than the maximum numeral value among the numbers, and a counter related to random access reaches a maximum value corresponding to the first number, transmitting the PRACH based on a second number among the numbers, wherein the second number is greater than the first number.

6. The method according to claim 1, further comprising:
determining the number of PRACH transmissions associated with the random access attempt among the numbers according to a measurement result of a downlink signal; and
determining the first number based on the determined number of PRACH transmissions associated with the random access attempt or the maximum value.

7. The method according to claim 1,
wherein the configuration information further comprises power related configuration information corresponding to each numeral value among the numbers, and
wherein the power related configuration information comprises at least one of: PRACH received power, a pathloss compensation coefficient, or a PRACH power ramping step.

8. The method according to claim 7,
wherein in case that the first number is different from the number of PRACH transmissions corresponding to a previous random access attempt, a preamble power ramping counter is increased by 1, and
wherein in case that the first number is not different from the number of PRACH transmissions corresponding to the previous random access attempt, a value of the preamble power ramping counter remains unchanged.

9. The method according to claim 8,
wherein in case that a power value equivalently increased by an increment between the first number and the number of PRACH transmissions corresponding to the previous random access attempt is not greater than a preamble power ramping step, or a difference between the power value equivalently increased and the preamble power ramping step is not greater than a first threshold, the preamble power ramping counter is increased by 1, and
wherein in case that a power value equivalently increased by an increment between the first number and the number of PRACH transmissions corresponding to the previous random access attempt is greater than a preamble power ramping step, or a difference between the power value equivalently increased and the preamble power ramping step is greater than a first threshold, the value of the preamble power ramping counter remains unchanged.

10. A method performed by a user equipment (UE) in a wireless communication system, the method comprising:
determining a number of physical random access channel (PRACH) transmissions associated with a random access attempt and corresponding random access occasions (ROs) based on configuration information related to random access;
determining to cancel a PRACH transmission on a first RO among the ROs; and
performing PRACH transmissions on other ROs among the ROs,
wherein the first RO is determined according to at least one of:
priority related to power allocation,
whether a symbol on the RO is flexible or not, or
an interval between the PRACH transmission on the RO and other signal transmissions.

11. The method according to claim 10, further comprising:
informing a higher layer to suspend a preamble power ramping counter, or
informing the higher layer of the number of transmitted PRACHs, or
in case that a number of the first ROs is greater than a third threshold, informing the higher layer to suspend a PRACH transmission counter or a random access attempt counter, or informing the higher layer to decrease a value of the PRACH transmission counter by the number of the first ROs or to decrease a value of the random access attempt counter by 1.

12. A method performed by a user equipment (UE) in a wireless communication system, the method comprising:
transmitting a physical random access channel (PRACH) based on a number of PRACH transmissions associated with a random access attempt; and
monitoring a physical downlink control channel (PDCCH) related to a random access response (RAR) related to the PRACH;
wherein a random access radio network temporary identifier (RA-RNTI) related to scrambling of the PDCCH is determined based on the number of PRACH transmissions.

13. The method according to claim 12,
wherein in case that the number of PRACH transmissions is 1, the RA-RNTI is determined based on an index of a first orthogonal frequency division multiplexing (OFDM) symbol of an RO of a single PRACH transmission corresponding to the number of PRACH transmissions, and
wherein in case that the number of PRACH transmissions is greater than 1, the RA-RNTI is based on an index of the second or a last OFDM symbol of a w-th RO among the ROs corresponding to the PRACH transmissions, and
wherein the w is obtained by performing a rounding operation on the number of PRACH transmissions divided by 2.

14. A user equipment (UE) in a wireless communication system, the UE comprising:
a transceiver; and
one or more processors communicatively coupled to the transceiver,
wherein the one or more processors are configured to:
receive configuration information related to random access, wherein the configuration information comprises at least one of first information on a number of physical random access channel (PRACH) transmissions associated with a random access attempt, or a maximum value related to the random access, and
transmit a first number of PRACHs, wherein the first number is determined based on the maximum value or the first information.

15. The UE according to claim 14,
wherein the first information comprises a set of numbers of PRACH transmissions, or
wherein the first information comprises a number of numeral values in a set of numbers of PRACH transmissions, the numeral values in the set corresponding to one or more numbers of PRACH transmissions.

16. The UE according to claim 14, wherein the maximum value is a maximum value of a number of times of PRACH transmissions, or a maximum value of a number of times of random access attempts.

17. The UE according to claim 16, wherein the maximum value comprises:
a maximum value corresponding to each of numeral values in the numbers of PRACH transmissions, or
by rounding a ratio of the maximum value to the number of the numbers of PRACH transmissions, a maximum value related to random access which corresponds to each numeral value of the numbers of PRACH transmissions is obtained.

18. The UE according to claim 14, wherein the one or more processors are further configured to:
in case that the first number of PRACH transmissions associated with a current random access attempt is less than the maximum numeral value among the numbers, and a counter related to random access reaches a maximum value corresponding to the first number, transmit the PRACH based on a second number among the numbers, wherein the second number is greater than the first number.

19. The UE according to claim 14,
wherein the one or more processors are further configured to:
determine the number of PRACH transmissions associated with the random access attempt among the numbers according to a measurement result of a downlink signal; and
determine the first number based on the determined number of PRACH transmissions associated with the random access attempt or the maximum value,
wherein the configuration information further comprises power related configuration information corresponding to each numeral value among the numbers, and
wherein the power related configuration information comprises at least one of: PRACH received power, a pathloss compensation coefficient, or a PRACH power ramping step.

20. One or more non-transitory computer-readable storage media storing one or more computer programs including computer-executable instructions that, when executed by one or more processors of a user equipment (UE), cause the UE to perform operations, the operations comprising:
receiving configuration information related to random access, wherein the configuration information comprises at least one of first information on a number of physical random access channel (PRACH) transmissions associated with a random access attempt, or a maximum value related to the random access; and
transmitting a first number of PRACHs, wherein the first number is determined based on the maximum value or the first information.
